(19) United States
(12) Patent Application Publication
(10) Pub. No.: US 2010/0131232 A1
(43) Pub. Date: May 27, 2010

(54) BELT SLIP METER

(76) Inventor: Timothy M. TAYLOR, Broken Arrow, OK (US)

Correspondence Address: THE GATES CORPORATION, IP LAW DEPT. 10-A3, 1551 WEWATTA STREET, DENVER, CO, 80202, US

(21) Appl. No.: 12/275,273

(22) Filed: Nov. 21, 2008

(51) Int. Cl. G01P 3/00; G21C 17/00

(52) U.S. Cl. 702/147; 702/183

(57) ABSTRACT

A meter for measuring belt slip in a belt drive system having at least a belt trained about two rotating elements. The meter comprises: two sensor inputs, to receive a digital signal related to the speed of a said rotating element; an external input, to accept a command or value; an output, to display or transmit a measurement or calculation result; and a controller, to calculate the relative speed of the two rotating elements, compare the relative speed to a set-point, and output a result indicative of belt slip.

### BACKGROUND OF THE INVENTION

1. Field of the Invention

This invention relates generally to a method and apparatus for measuring relative rotational speed of two rotating machine elements, more particularly to a method and system or apparatus for measuring belt slip in a belt drive system, and specifically to a belt slip meter.

2. Description of the Prior Art

Belts, including V-belts, multi-ribbed belts and flat belts, transmit power between rotating machine elements through friction and are therefore prone to some degree of slippage between belt and pulley or sheave. Excessive slippage, or slip, can rapidly wear out a belt, damage pulleys, create noise, generate heat, waste energy, and the like. These problems can be observed by stopping the drive and inspecting the belt and/or pulleys; listening for or measuring noises; or measuring temperatures or speeds and tracking them over time; or the like. However, these detection methods either require interrupting the operation of the equipment, or severe enough malfunction of the drive to draw attention, or to create inconvenience.

U.S. Pat. No. 3,637,998 discloses a speed ratio measuring system with a ratio counter that provides a measure of the speed ratio of a cooperative pair of work rolls on a reversing roughing mill.

U.S. Pat. No. 4,849,917 discloses a device for measuring the speed difference between the speed of a belt and the peripheral speed of a drum in strip casting.

U.S. Pat. No. 4,823,080 discloses a combination touchless (photo type) and contact type tachometer having a digital display.

### SUMMARY

The present invention is directed to systems and methods which provide a non-invasive, direct measurement of belt slip which can indicate a belt drive problem before severe malfunction occurs. The present invention provides for automated belt slip measurement in real time on an operational belt drive. The present invention thus provides a monitoring and diagnostic device for belt drives based on belt slip measurement.

The present invention is directed to a meter for measuring belt slip in a belt drive system having at least a belt trained about two rotating elements, comprising: two sensor inputs, to receive a signal related to the speed of a rotating element; an external input, to accept a command or value; an output, to display or transmit a measurement or calculation result; and a controller, to calculate the relative speed of the two rotating elements, compare the relative speed to a set-point, and output a result of the comparison that is indicative of belt slip.

The set-point may be a stored measurement of the relative speed of the two rotating elements or a value provided via an external input and subsequently stored. The result indicative of belt slip may be a ratio of a relative speed measurement to the set-point or a percent difference between them. The result indicative of belt slip may be compared to a stored value indicative of a tolerable amount of slip and an alarm may be generated if the belt slip result exceeds that amount. Alternately, the belt slip result may be compared to additional stored values representing multiple alarm or warning levels indicating various degrees of slip.

Sensors useful in embodiments of the invention include various non-contact sensors, such as optical, infrared, or laser sensors sensitive to one or more targets rotating in conjunction with or on rotating elements of a drive system. The targets may be a reflective surface such as reflective tape, paint, or the like. If more than one target is present on a rotating element, then the number of targets may be input to the meter so that the controller may properly calculate the time of one full revolution of the rotating element. The speed measurement of each rotating element may be accomplished by measuring for each corresponding signal the width of a high voltage pulse and a subsequent low voltage trough to determine the time for one revolution of the element. The drive ratio of two drive elements may then be calculated from two such times, which may also be inverted and scaled to provide rotational speed data.

Embodiments of the present invention are also directed to methods for measuring and displaying belt slip. The inventive embodiments are also directed to a belt drive system having a belt drive with at least a belt and two pulleys, two targets, two sensors, a belt slip meter, and a tensioning device. The sensors and meter may communicate wirelessly.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

The accompanying drawings, which are incorporated in and form part of the specification in which like numerals designate like parts, illustrate embodiments of the present invention and together with the description, serve to explain the principles of the invention. In the drawings:

FIG. 1 is a diagrammatic representation of an embodiment of the invention;

FIG. 2 is a diagram of the voltage signal in accordance with an aspect of various embodiments of the present invention;

FIG. 3 is a diagrammatic representation of another embodiment of the invention; and,

FIG. 4 is a diagrammatic representation of another embodiment of the invention.

### DETAILED DESCRIPTION

The slip meter according to the invention dynamically measures and displays the percent slip or other indication of slip or slip rate of a belt drive. The meter compares measured values of slip to a set, acceptable value of slip, and provides a visual warning indicator when slip becomes excessive. A maintenance person or end user is thus able to continuously monitor the belt drive without shutting it down for a belt inspection. The slip meter may be a portable, handheld meter or a permanently mounted meter. Updates can occur continuously, providing a real-time measure of slip, which may also be viewed as a measure of energy loss, and ultimately a measure of belt performance. It should be understood that generally the term “percent slip” herein can mean any desired indication of belt slip.

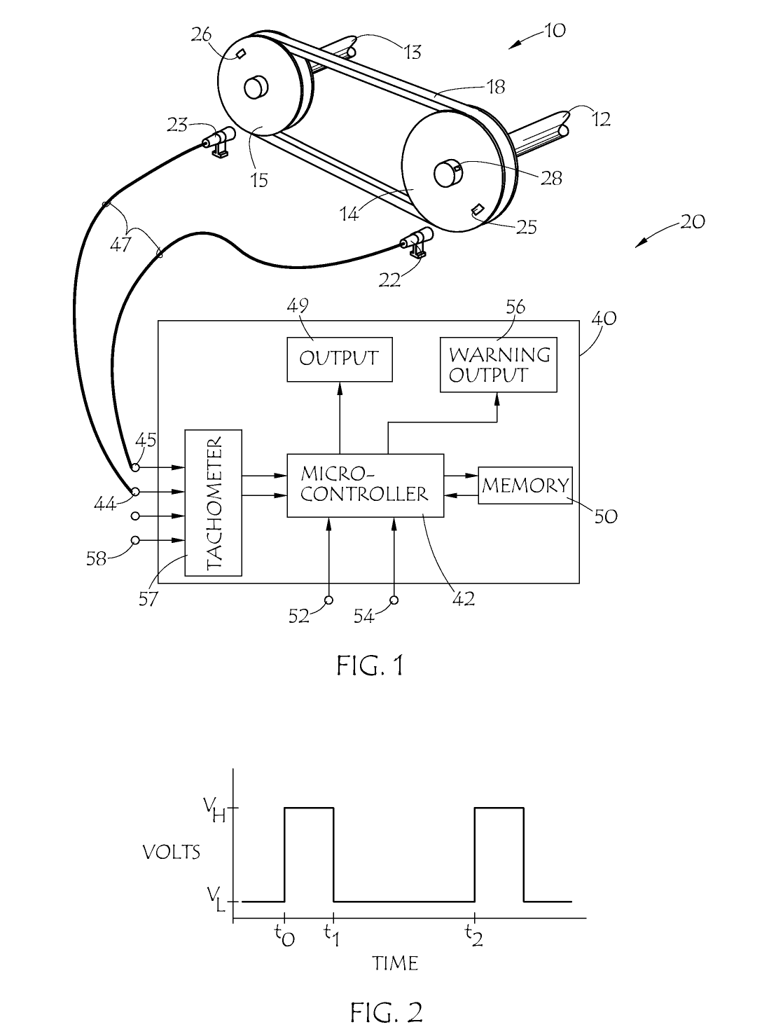

The present invention is directed to a belt slip measurement system which integrates two tachometers, a speed ratio and slip calculator, and outputs. An embodiment of such a system is illustrated in FIG. 1. In FIG. 1, belt slip measurement system 20 includes components mounted on or near belt drive system 10 and meter 40. Illustrated belt drive system 10 includes two rotating elements in the form of shafts 12 and 13, one of which may be a driver and the other a driven shaft. Mounted on shaft 12 is pulley 14, and on shaft 13 is pulley 15. Belt 18 is trained about pulleys 14 and 15 and transmits motion or power from one pulley to another. Various shaft mounting devices, driver devices such as motors, and driven devices may be used as part of a belt drive system, but are not shown. The slip measurement system includes marker or target 25 on pulley 14 which is detected by sensor 22 which transmits a first signal to input 45 of belt slip meter 40. Likewise, marker 26 on pulley 15 is detected by sensor 23 which transmits a second signal to input 44 on meter 40. Meter 40 includes tachometer 57, which receives the two sensor signals at inputs 44 and 45 and determines the rotation rate or rotational speed of the two rotating elements. Meter 40 includes microcontroller 42 which calculates first the speed ratio of the two rotating elements from the tachometer signals and then the percent slip of the belt, based on a set point for the speed ratio which is stored in memory 50. The set point in memory may have been entered by a user command at input 52, for example, transmitted from another device using input 52, or measured previously on command. The speeds of the two rotating elements and the percent slip may be output or displayed simultaneously at output 49. The percent slip value may also be compared to one or more predetermined threshold value, and a warning sent to output 56 if a threshold value is exceeded. Other inputs, such as input 54, may be provided, for example, to permit a user command, for example to signal for a fresh measurement, store a new set point value, clear a warning signal, or the like. A multiplexer or other means of handling additional sensor inputs 58 may be provided so multiple belt drive systems may be monitored. Tachometer(s), multiplexer, memory, and/or microcontroller may be integrated or separate but interconnected circuitry.

Markers or targets 25 and 26 are shown on an axially facing pulley surfaces in FIG. 1. The markers could instead be mounted on the shaft ends or on a radially facing surface of a shaft or pulley as illustrated by target 28 on shaft 12. An important consideration is to mount the targets or markers where the sensors can detect them, and the available positioning options for a sensor may dictate the preferred position of the target. A target may be a reflective surface such as a piece of reflective tape, paint, coating, or the like. Reflective tape is particularly suited for use with optical sensors, including for example, infrared, laser, or other sensors. A marker or target may be a perforated wheel mounted on a shaft or a ring mounted on a pulley. A plurality of markers may be used on one or both rotating elements, in which case means may be provided for inputting the number of markers to the microcontroller and or its tachometer for use in calculating the rotational speed of the corresponding elements.

FIG. 1 shows sensors 22 and 23 connected by signal wires 47 to inputs 44 and 45. In other embodiments of the invention, wireless transmitting and receiving devices may be used to accomplish the signal transmission. Likewise, the details of the circuitry for accomplishing may vary, so that a single integrated circuit may provide all or most of the functions discussed for meter 40, or multiple individual circuits may be used. Microcontroller 42 might use a stored program in associated memory 50 for directing or carrying out its functions.

It is preferred that the sensors generate a digital signal in response to the rotating markers. By digital is meant a signal with primarily two states, for example a high and a low voltage level, or an on and off state. The two voltage levels may conform to any conventional digital signal standard, for example TTL (i.e., Transistor-Transistor Logic, which uses discrete levels of 0 and +5 volts). In a preferred embodiment, the signal is high or on when the target is detected by the sensor and low or off when the target is not detected by the sensor. Thus, a signal such as illustrated in FIG. 2 may be provided by the sensors. Referring to FIG. 2, the marker is sensed from time t₀ to t₁, (the “on-time”) and the marker is not sensed from t₁ to t₂, (the “off-time”). The total time for a single, complete rotation of a rotating element of the drive is thus the sum of one on-time and the subsequent off-time or vice versa. The tachometer 57 is thus preferably able to detect the signal transitions from low to high or off to on and vice versa, measure the individual pulse widths and add a single sequential on-time and off-time. An internal program may direct the microcontroller to watch for a positive pulse from a sensor, and when a pulse is detected, to time the pulse to determine the on-time. The program or microcontroller may then store the on-time data. The same may be done for the off-time. Once both on- and off-time values are measured, the controller or program may sum the two time values to determine the time to complete one revolution. The calculated time may be inverted and unit conversions applied in order to determine and display a desired form of rotational speed, for example, revolutions per minute (“RPM”), angular velocity, or linear rotational speed, or the like. This may be done in sequence for each pulley or rotating element in the drive system. This method of determining the rotational speed of the rotating elements provides for very quick response time, since a single revolution or rotation is all that is necessary. If data smoothing is desired, a number of single-revolution readings can be averaged. Such an average could be implemented for example by means of a stored program that directs the microcontroller.

While a single target on a pulley is preferred, multiple targets may be used provided that the number of targets may be provided to the microcontroller by some input means so that the proper number of pulses may be timed to determine the time of a single revolution of a rotating element. Subsequent calculations carried out by the controller may be the same as in the single marker case.

Alternately, when one or multiple markers are used on a rotating element, in combination with an internal timer, the controller could determine the total number of consecutive signal pulses in a given time interval. Thus, the rotational speed may be determined by the number of times a marker is detected in a predetermined time reference, using knowledge of the number of markers per revolution. An additional stored constant is needed to use multiple targets. Accuracy would be a function of the length of time chosen for counting pulses and the number of targets. A large number of targets and/or a long time may be needed to achieve the accuracy of the preferred method of timing one target for a single revolution. Regardless, it simplifies the meter and reduces the programming space or memory required by using a single target all the time.

In various embodiments, once the rotational speeds of two pulleys have been measured, the microcontroller calculates the ratio of the two speeds. The speed ratio is independent of the units used for rotational speed and therefore may be determined directly from either the measured time for one revolution of each pulley or from the inverted or converted form of the rotational speeds. The percent slip is determined by a comparison of the speed ratio to a value of a speed ratio which represents zero slip. The zero slip value may be known from the design speed ratio of the belt drive system, or may have been measured previously, for example by the same slip meter. The belt slip meter can store such a zero slip value, or similar set-point for the drive, for later use. The meter can perform a drive ratio measurement on command and store it as the set-point speed ratio for later use. The meter can also, or instead, receive a set-point value directly from a user or some electronic input. The percent slip of the belt on the drive system is then easily calculated as the magnitude of the per cent difference between the current value of speed ratio and the set-point value. Alternately, if desired, some other indication of slip or slip rate may be utilized, such as a speed ratio difference, slip ratio, percent of nominal, fractional slip, or fraction of nominal or the like, instead of actual percent slip. Regardless of the form of the slip rate indication chosen in a particular embodiment of the slip meter, the slip indication may then be programmatically compared to a predetermined and programmed-in level or levels by the controller to decide if a warning indication is needed. In the case of actual percent slip with respect to V-belt drives, it may be useful to send a warning when the percent slip is greater than about 3%. Generally, for example in typical V-belt drives, a value of slip above about 8% indicates a severely degraded drive condition needing maintenance. Thus, two predetermined warning levels may be advantageously utilized.

Thus, the inventive slip meter and slip measurement system provide a number of advantages over other means of diagnosing drive problems. The slip measurement may be carried out on an operational belt drive system. Unlike some other diagnosis techniques, such as direct inspection of a belt, the drive does not need to be shut down first. The slip measurement may be fully automated. The slip measurement is objective and can provide early warning of problems before subjective symptoms, such as belt noise, become severe enough to warrant attention. The slip measurement may be carried out remotely from the belt drive itself. The slip meter can be extremely portable for field use. The slip meter can be incorporated into a network or central control system.

FIG. 3 shows an embodiment of the invention in the form of belt slip meter 60. Meter 60 illustrates an embodiment with a minimum number of visible features. Meter 60 is housed in box 62 and includes two inputs 68 and 70 for receiving signals from two rotation speed sensors, not shown. Meter 60 also includes output 64, which may be a display such as an liquid crystal display (“LCD”) or the like, having a numerical display area 66 for displaying the two rotational speeds, the percent slip, the set point values, instructions, or the like. Meter 60 also has output 67 in the form of a warning light for when a slip value exceeds a threshold level. User inputs 72, 74, and 76 illustrate a sort of minimal user interface for taking a measurement, entering set point values, and saving values to memory. Meter 60 may prompt a user for a series of decisions or values to be entered. Inputs 74 and 76 represent a means to tell the meter to increase or decrease a displayed value to attain a predetermined value which may be stored in memory upon user activating input 72, i.e., pushing an “enter” button. With minimal features, meter 60 could be made very small and portable. It could be hand-held or mounted in a suitable location.

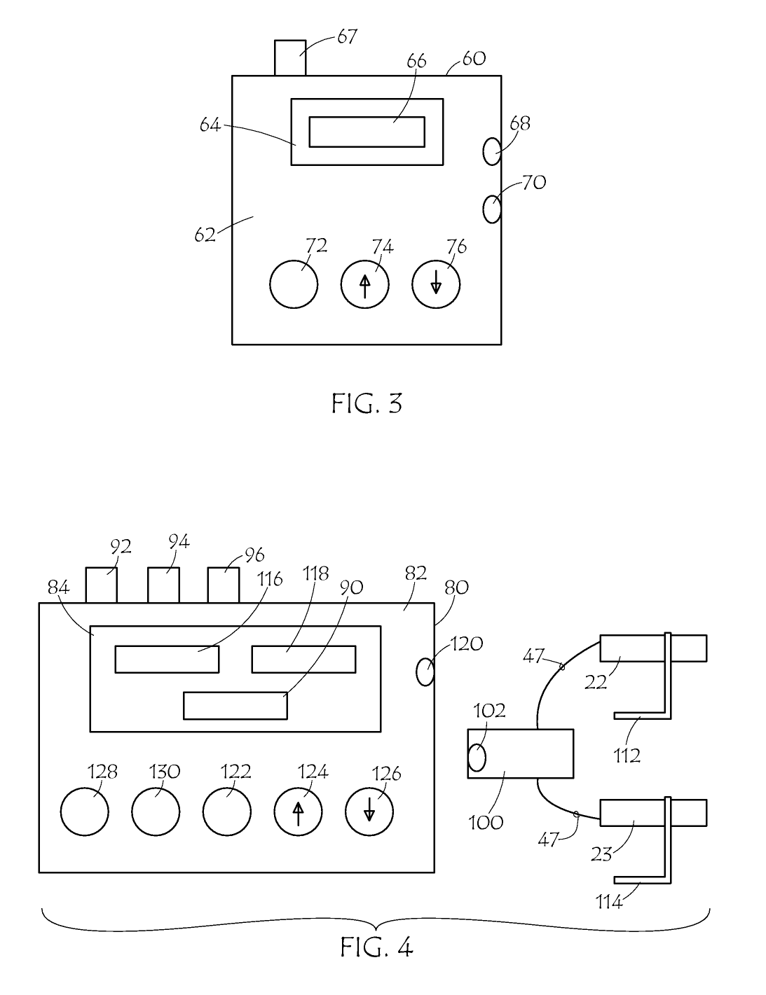

FIG. 4 represents a somewhat more full-featured embodiment of a slip meter. In FIG. 4, belt slip meter 80 is illustrated with wireless input 120 for receiving signals from wireless transmitter or transceiver 102 which is part of tachometer unit 100. As in other embodiments, sensors 22 and 23, mounted on brackets 112 and 114, sense rotation rates of two rotating elements and provide a signal to tachometer unit 100 via connections 47. Slip meter 80 has similar internal features as in embodiments already described, namely, a microcontroller, memory for a set point, stored program, et cetera, and the like. External inputs are more numerous and selected for easier input and control by the user. Input 128 may be used to indicate the user wishes to enter the number of targets on the rotating element. Input 130 may be used to indicate the user wishes to enter a drive ratio or set-point for use by the microcontroller in calculating the percent slip. Input 122 may be an “enter” and/or “start-stop” button to indicate the user is ready to accept displayed value as number of markers, set-point, or take a new reading. Inputs 124 and 126 may be used to increase or decrease a displayed number or value to arrive at a desired value to be entered, whether a set-point or number of targets. Output device or display 84 on meter 80 is larger than in meter 60 so that several values or results can be displayed simultaneously. For example, it may be advantageous to display at areas 90, 116, and 118 the rotation rate of each of the two rotating elements and the percent slip result, respectively. Additional values may be displayed as desired, such as the set-point, the number of targets, the measured drive ratio, and/or the like. The warning outputs 92, 94, and 96 on meter 80 may be used to indicate results of comparing the percent slip to a number of threshold values. For example, output 92 could be used to indicate acceptable operation, for example, with a green light. Likewise, output 94 could indicate a moderate level of slip by means of a yellow warning light, and output 96 could indicate a dangerous level of slip with a red warning light. Other warning indicators could be used, such as an indication on a part or display 84 in the form of words, flashing words or colors, and/or sounds or the like. The internal program could also, or instead, provide menus for user selection of the various functions, or provide a script or predetermined sequence of operation for the user to follow. Meter 80 could be portable or mounted in a suitable location.

Other or alternate output devices useful in embodiments of the present invention could be interface connectors or wireless transmitters, receivers, or transceivers, Ethernet, USB or Bluetooth capability, for use with external devices such as displays, printers, controllers, computers, or networks. Likewise, alternate external input devices could be used, such as keyboards, touch screens, various wired connections, wireless transmitters, receivers, transceivers or other devices, computers, controllers, or networks or the like.

### EXAMPLES

A slip meter according to one embodiment of the invention and appearing similar to the illustrated embodiment of FIG. 3 was constructed. The meter uses a stand-alone microcontroller. The meter measures RPM of each pulley continuously, using one or more reflective piece of tape detected by an infrared (“IR”) sensor, by summing the on-time and off-time, respectively, of each revolution of each pulley. The IR sensors provide a digital TTL output to the microcontroller which converts the total pulse width time in milliseconds to an RPM value for each pulley depending on the number of targets affixed to the pulley. The IR sensors utilized in the examples provide accurate readings at up to 3 feet of distance between the sensor and the target. Accurate measurements were achieved at or above 150 RPM with 4 targets on each pulley. It is contemplated that different sensors could increase the reading distance, and/or faster microcontrollers would improve accuracy and/or RPM measurement range when using one target.

Two slip meters according to other embodiments of the invention and appearing similar to the illustrated embodiment of FIG. 4 were also constructed, one wired and one wireless. These meters used a 5-button interface and a 4×20-character LCD display. The meters each were powered by a 9-volt battery or a permanently wired 9-volt DC power supply. The meters could be permanently mounted on the guard or base of one critical belt drive, or could be used as a portable meter for many different drives throughout a plant. One meter was wired so that two IR sensor inputs may be connected directly into the side of the unit. The other meter was wireless in that two rotational speed sensors could be connected to a remote transceiver or tachometer mounted near a belt drive which transmitted RPM data wirelessly to the belt slip meter monitoring instrument housing a microcontroller, a transceiver, and the displays and buttons. Wireless transmission of collected data was achieved using two 912 MHz transceiver pairs, or other equivalent means. Constants and button commands were wirelessly sent to the remote tachometer, and the data collected was then received from the tachometer, manipulated, and displayed on the LCD screen of the slip meter under control of a microcontroller and resident program. Multiple, permanently-mounted tachometer boxes can be mounted on many separate drives, which could all connect to a single hand-held slip meter with wireless receiver. The wireless receiver used can read a signal up to 900 feet away from a belt drive. It is contemplated that more powerful wireless transceivers could increase the reading distance as needed. Thus, a user can continuously monitor multiple, belt drive systems from a central location such as an office or control room at a distance or remote from the belt drives themselves.

In both 5-button example meters, the user could input a target drive ratio, or set-point or zero-slip value, based on two measured RPMs by pressing a “ratio” button, using the increase and/or decrease buttons to generate the desired value, and finally pressing an “enter” button. Alternately, the meters could “zero” on any two measured RPMs by calculating the zero-slip ratio at the time a button is pushed. Once a zero-slip value is stored, the meters can provide a measure of relative slip. The LCD screen displayed the two shaft or pulley speeds and the relative slip simultaneously. Three colored indicator lights were included as a visual display of the amount of slip in the drive: a green light indicating normal operation with less than about 3% slip, a yellow light indicating slip greater than 3% but less than about 8%, and a red light to indicate slip greater than 8%. The red light could also indicate that no value had registered on the meter, for example, indicating belt breakage or drive power failure.

It should be noted that the above examples are not meant to limit the invention. For example, details such as the choice of power supply or output device, the range of sensors or transceivers, the speed of the microcontroller and useful speed range of the meter, and the like, may be readily altered by suitable choice of components.

In other embodiments of the invention, a menu structure may be programmed into the device. The menu structure may include simple introductory statements and then prompt the user to enter a drive ratio or alternately a speed for each sheave as the set-point value. The speed ratio may be checked or limited to a range, for example from 1.00 to 10.00, with prompts to inform the user of these limitations. Alternately, the user may select a current measurement to be stored as the set-point. The menu may also prompt for the entry of the number of targets per sheave. There may be a warning about low RPMs and/or the need for multiple targets per sheave.

Either a known or a calibrated speed ratio is used to calculate a dynamic percent slip of a V-belt. The above examples allow the ratio to be set either in the menu structure of the program by user input or for the ratio to be calibrated using the “Set Ratio” command which will then measure the RPMs of each respective pulley and calculate a speed ratio. When the “Set Ratio” button is pressed, the value of ratio is immediately calculated (and stored) based on a measured relative rotation rate. Accordingly, the slip is set to zero and ongoing calculations of percent slip are performed based on that set-point.

Slip meter embodiments do not necessarily require, but can be equipped with, an interface to an existing control system in a building, or industrial, manufacturing or other environment. A slip meter can also be equipped with a multiplexer to make it a central monitoring station for one or more belt drives each transmitting RPM data for that drive. The wireless version of the meter can be equipped with a wireless interface for monitoring one or more drives or communicating with an existing control system.

According to various embodiments of the invention, a number of optional features could be incorporated. “Light towers” can be implemented on or near the meter to display an indication of slip. One or more optional sensors to measure a belt's running temperature, using a heat spy or other thermal sensor, can be included to provide an additional indication of belt performance. Likewise, ambient temperature and/or humidity measurements can be acquired and displayed with appropriate circuitry. Vibration monitoring of the equipment using accelerometers can be designed into the meter. Noise sensors may likewise be included. Intelligent, feedback control of an electronic/pneumatic/hydraulic actuator system can be implemented into embodiments of the slip meter to allow for continuous adjustment of tension in a belt drive system to optimize belt life and performance based on slip measurements.

The slip meter is used to diagnose belt performance while the drive is in operation for predictive maintenance or repair or overhaul purposes. By implementing a slip-meter into a V-belt drive system, the user can easily determine the required time to re-tension a belt drive, optimize belt life, prevent downtime, and reduce energy loss. Energy savings are possible because percent slip is a good indication of energy loss, which can be reduced or substantially eliminated by proper belt system maintenance. Energy loss can be converted to a monetary value or cost and/or displayed for example in currency units. Applicable belt drive systems are found for example in air handling equipment (air conditioning and heating), conveying systems, fluid pumping systems, and the like. A portable meter could be taken from drive to drive to measure the slip of each quickly and easily. A permanently mounted unit would continuously monitor process critical applications.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps. The invention disclosed herein may suitably be practiced in the absence of any element that is not specifically disclosed herein.

What is claimed is:

1. A meter for measuring belt slip in a belt drive system having a belt trained about at least two rotating elements, comprising:
two sensor inputs, to receive input signals related to the rotational speed of said rotating elements;
an external input, to accept a command;
a controller, to calculate from said input signals the relative rotational speed of the two rotating elements, to store a set-point on receiving said command, to compare said relative speed to said set-point, and to generate from said comparison a result indicative of belt slip; and
an output, to transmit said result.

2. The meter of claim 1 further comprising a second output to transmit a warning, and wherein said controller is further to output said warning based on comparing said result indicative of belt slip to one or more predetermined warning levels.

3. The meter of claim 1 wherein said result is at least one selected from a slip ratio, a percent slip, an energy loss, and an energy cost.

4. The meter of claim 1 wherein said input signals are responses to a single target on each rotating element, and wherein said calculation of relative speed includes measuring for each of the two rotating elements the time for one full rotation.

5. The meter of claim 1 wherein said input signals are responses to a plurality of targets on each rotating element, and wherein said calculation of relative speed includes measuring the time for at least one full rotation of each rotating element, and wherein said meter further comprises an external input to accept the number of said targets on a rotating element.

6. The meter of claim 1 wherein said signals are digital and have variable pulse width.

7. The meter of claim 1 wherein said meter displays the rotational speed of each said two rotating elements and the result indicative of belt slip.

8. The meter of claim 1 further comprising a remote wireless transmitter housing said sensor inputs to transmit said input signals or said speed of said rotating elements; and a wireless receiver to provide said transmission to said controller.

9. The meter of claim 1 further comprising a multiplexer to handle signals from a plurality of belt drive systems.

10. A meter for measuring belt slip in a belt drive system comprising:
two sensor inputs, each for receiving a variable-width input signal from a sensor, said variable width indicative of the rotational speed of a rotating element of said drive system;
a first external input, to accept an external command to store a set-point;
a second external input, to provide a set-point value for storage on said command;
an output, to transmit a measurement result;
a controller for processing each said input signal received at the two sensor inputs and generating a measurement result including:
determining from the width of each said input signal the time for one full revolution of the corresponding rotating element;
calculating a ratio of the two times;
upon said external command either storing an instance of said ratio as said set-point or, if provided, storing the set-point value as said set-point;
calculating a slip indication by comparing another instance of said ratio and said set-point;
transmitting to said output said slip indication as a measurement result.

11. The meter of claim 10 wherein said input signal comprises a sequence of high and low voltages generated by the sensor in response to the movement of a target rotating with said rotating element; and wherein said determining comprises detecting the rise of the voltage to a high, measuring the time lapse for that high and the next low which corresponds to one full revolution of said rotating element.

12. The meter of claim 10 further comprising:
an alarm; and
wherein said controller is further for: comparing said slip indication to a predetermined slip level to determine if a warning should be sent; and activating said alarm if a warning should be sent.

13. The meter of claim 10 wherein said output comprises a visible display of the rotational speed of each rotating element and said slip indication.

14. The meter of claim 10 wherein said sensor inputs are wireless receivers.

15. A method comprising:
placing a first target to rotate with a first drive element in a belt drive system;
placing a first sensor to sense said first target and generate a first digital signal corresponding to the rotation of said first drive element;
placing a second target to rotate with a second drive element in a belt drive system;
placing a second sensor to sense said second target and generate a second digital signal corresponding to the rotation of said second drive element;
timing said first and second digital signals to determine the corresponding times for one revolution of said first and second drive elements;
calculating a measured drive ratio from said times for one revolution;
storing a set-point from the calculating of a measured drive ratio or from an external input of a specified drive ratio;
calculating a slip indication from a measured drive ratio and from said stored drive ratio set-point;
outputting said slip indication.

16. The method of claim 15 further comprising:
comparing said slip indication to a alarm value and outputting an alarm if said predetermined alarm value is exceeded by said slip indication.

17. The method of claim 15 wherein said slip indication is a ratio of said measured drive ratio and said stored set-point or is a percent or fractional difference between said measured drive ratio and said stored set-point.

18. The method of claim 15 further comprising: averaging two or more times of revolution for a drive element.

19. A belt slip measurement system comprising: two sensors, at least two targets for placement of at least one on each of two rotating belt drive elements to be measured, and a meter;
each of said sensors adapted to detect the presence of said target and generate a digital signal as said target rotates past said sensor such that a sequence of at least one high and one low represents one revolution of said drive element;
said meter comprising:
two sensor inputs for receiving said signals;
an external input, for accepting a command to store a computed result and for receiving a user-selected value;
at least one output device, for displaying results and a warning; and
a controller for processing said each signal including:
calculating the period of a set of consecutive high and low values corresponding to a single rotation of a corresponding drive element and inverting that period and converting the result to rpm units;
calculating the ratio of the two rpm results;
storing said ratio as a set-point value on receiving said command at the external input;
storing a user-selected set-point value upon receipt at the external input;
calculating a slip rate result based on said ratio and said set-point value;
comparing said slip rate result to a predetermined slip rate level to determine if a warning should be sent; and
sending said rpm results, said slip rate result and said warning to said output device.

20. The belt slip measurement system of claim 19 wherein said sensors are non-contact sensors.

21. The belt slip measurement system of claim 20 wherein said signals are transmitted wirelessly to said meter.
